(19) United States
(12) Patent Application Publication
(10) Pub. No.: US 2019/0168615 A1
(43) Pub. Date: Jun. 6, 2019

(54) ELECTRIC PUBLIC TRANSPORT LAND VEHICLE, PROVIDED WITH BATTERY PROTECTION COVER(S)

(71) Applicant: BLUEBUS, Ergue Gaberic (FR)

(72) Inventors: Patrice BESSON, Marennes (FR); Luc NEDELEC, L'Hopital Camfrout (FR)

(21) Appl. No.: 16/095,864

(22) PCT Filed: Apr. 20, 2017
(86) PCT No.: PCT/EP2017/059414

§ 371 Date: Oct. 23, 2018

(30) Foreign Application Priority Data
May 18, 2016 (FR) 1654402

(51) Int. Cl. B60L 3/00; B60L 50/60; B60K 1/04; H01M 2/10; H01M 2/12; H01G 11/10; H01G 11/14; H01G 11/78

(52) U.S. Cl. CPC B60L 3/0046; B60L 50/66; B60K 1/04; H01M 2/1083; B62D 25/08; H01G 11/10; H01G 11/14; H01G 11/78; B60L 2200/18; H01M 2/127

(57) ABSTRACT

An electric public transport land vehicle, in particular of the bus, coach or tyred tram type, including at least one rechargeable electrical energy storage module arranged in a peripheral panel of the vehicle, and having, for at least one electrical energy storage module, a protective cover equipped with at least one evacuation opening allowing smoke and/or flame and/or gas to escape in a direction away from the vehicle in the event of fire in the module.

The present invention relates to an electric public transport land vehicle, of the bus, coach or tyred tram type, equipped with protective cover(s) for electrical energy storage modules, in particular those that are rechargeable.

The field of the invention is the field of electric public transport land vehicles of the bus, coach or tyred tram type, equipped with rechargeable electrical energy storage modules for supplying at least one electric motor of said electric vehicle.

### BACKGROUND

In order to reduce pollution in built-up areas, the use of electric vehicles is undergoing rapid growth, encouraged both by user awareness and also by administrative incentives promoting the purchase and use of electric vehicles. Thus the number of electric vehicles is continuously increasing in all fields: private road vehicles, rental-type shared use vehicles, public transport vehicles, etc.

The development of electric public transport land vehicles raises the question of the risks and consequences associated with the electrical batteries fitted in these vehicles, in particular in the event of fire. Indeed, a fire breaking out in an electrical battery can spread throughout the vehicle, and in particular in the passenger compartment of the vehicle, at a greater or lesser speed depending on the positioning of the battery in the vehicle, but also on the battery technology. Such a fire can have very serious consequences for the vehicle and for the people located on board the vehicle.

A purpose of the invention is to propose an electric public transport land vehicle, in particular of the bus type, in which the risks associated with a battery fire are reduced.

A further purpose of the invention is to propose an electric public transport land vehicle, in particular of the bus type, making it possible to reduce the damage to said vehicle in the event of a battery fire in said vehicle.

It is also a purpose of the present invention to propose an electric public transport land vehicle, in particular of the bus type, making it possible to better protect the people on board said vehicle and/or getting off said vehicle in the event of a battery fire in said vehicle.

### SUMMARY OF THE INVENTION

The invention makes it possible to achieve at least one of these aims by means of an electric public transport land vehicle, in particular of the bus, coach or tyred tram type, comprising at least one rechargeable electrical energy storage module arranged in a peripheral panel of said vehicle, characterized in that it also comprises, for at least one electrical energy storage module, a protective cover equipped with at least one evacuation opening that allows the smoke and/or flame and/or gas to escape in a direction away from the vehicle in the event of fire in said module.

Thus, the invention proposes to provide, for at least one electrical energy storage module of the electric vehicle, a protective cover comprising one or more openings allowing smoke and flames to escape in the event of fire in said module. Such a protective cover makes it possible to direct flames and smoke towards the outside of the vehicle, which makes it possible to reduce, or even to avoid, the spread of flames and/or smoke in said vehicle, and in particular in the passenger compartment of said vehicle. Thus, in the vehicle according to the invention, the risks associated with a fire in an electrical energy storage module of said vehicle are reduced.

In addition, smoke and flames created by a fire in an electrical energy storage module being directed out of said vehicle by the evacuation openings reduces damage to the vehicle and decreases the danger to people aboard the vehicle or near to the vehicle.

In the present application, by “storage module” is meant an assembly comprising one or more electrical energy storage elements of the battery or supercapacitor type, optionally arranged in a rigid outer shell. The storage module can also be equipped with trim that may comprise:
a support plate on which the outer shell is firmly fastened, and/or
one or more lateral support pieces, placed on at least one side, such as bars, hollow tubes or angle bars.

Advantageously, at least one protective cover of a module can have a shape folded on at least two of its sides, in particular a “U” shape, so as to cover a first face of said module, turned towards the outside of said vehicle, and at least a portion of two faces of said module adjacent to said first face.

Such a cover makes it possible to better protect the electrical energy storage module.

Preferentially, for at least one protective cover, at least one, in particular each, evacuation opening can be equipped with a louvre.

Such a louvre makes it possible to direct the evacuation opening in a desired direction, so as to direct smoke and/or flames and/or gas from a fire towards an area less dangerous to the vehicle and/or for the people on board or in the vicinity of the vehicle.

In a first embodiment, at least one louvre can be fastened or fixed.

Alternatively, at least one louvre can be mobile, in rotation, in particular about an axis parallel to the peripheral panel in which the storage module is arranged.

In this latter case, the rotation of the louvre can be adjusted, for example by a motor or a cylinder provided for this purpose.

Alternatively, the rotation of the mobile louvre can be carried out naturally by smoke and/or flames and/or gas, or hot air, created by the fire.

Advantageously, at least one opening of the protective cover can be directed in a direction forming an angle greater than or equal to 30° with respect to the peripheral panel, and in particular an angle comprised between 30° and 60°, and even more particularly an angle equal to 45°.

Such a direction imposed on the evacuation opening makes it possible for flames and/or smoke and/or gas caused by a fire to escape in a guided manner.

Such a direction can be imposed on the evacuation opening utilizing a louvre as described above, inclined according to an angle indicated above.

According to an embodiment, at least one electrical energy storage module can be placed in the upper panel, or in the roof, of the vehicle.

In particular, at least one module can be placed in a housing, called a cradle, provided in the thickness of the roof of the vehicle so that it does not project outwards from the upper face of the upper panel of the vehicle.

The protective cover of at least one storage module placed in the upper panel can advantageously be placed above said module, in particular so that it does not project outwards from the upper face of the upper panel of the vehicle.

Advantageously, at least one evacuation opening of at least one protective cover can be directed in a direction away from a panel of the vehicle comprising doors for passengers to board and get off a passenger compartment of said vehicle.

Such a direction is, generally but not necessarily, directed towards the road and away from the pavement.

This architecture makes it possible to reduce the risks to people getting off the vehicle in the event of fire, and for people close to the vehicle.

The vehicle according to the invention can comprise at least one electric/electronic management box for at least one storage module. Such a box can be positioned on the periphery of the storage module.

In this case, at least one evacuation opening of the protective cover can be preferentially directed in a direction away from said at least one electric/electronic management box, so as to protect said management box in the event of fire.

Alternatively or in addition, at least one protective cover can extend between at least one electric/electronic management box and at least one storage module.

Thus, the protective cover makes it possible to confine the storage module with respect to the management box, and vice versa, so that the management box is better protected in the event of fire in a storage module.

Alternatively or in addition, at least one storage module can be placed in, or on the side of, a rear panel of said vehicle.

In particular, at least one storage module can be placed in a housing, called rear housing, provided on the side of the rear face of said vehicle.

The protective cover of at least one storage module placed in the rear panel can be placed in front of said module, viewed from the rear panel.

In this embodiment, at least one evacuation opening of the protective cover can be directed downwards, i.e. towards the ground.

In particular, when the evacuation opening is equipped with a louvre, this latter can be inclined downwards, i.e. towards the ground.

This architecture makes it possible to reduce the risks to people located in proximity to the rear of the vehicle, such as people located on a pavement or people getting on or off the vehicle by a rear portion of the vehicle.

The vehicle according to the invention can comprise several adjacent modules, in particular placed in several compartments independent from one another.

The storage modules can also be aligned in a given direction.

For example, the vehicle according to the invention can comprise several, in particular four, adjacent modules placed on the side of its upper panel. In this case, the storage modules can be aligned in a longitudinal direction of the vehicle, generally horizontal.

Alternatively or in addition, the vehicle according to the invention can comprise several, in particular four, adjacent modules placed on the side of its rear panel. In this case, the storage modules can be aligned in a vertical direction.

In the case where the vehicle comprises several storage modules, the vehicle according to the invention can comprise an individual protective cover for at least one, in particular for each, of said adjacent modules. Such an individual protective cover makes it possible to access each module independently and has dimensions and a weight making it easier to handle.

Alternatively or in addition, the vehicle can comprise a protective cover common to at least two, in particular to all, of the adjacent modules. Such a common protective cover makes it possible to reduce the time and labour for its installation.

In the case where the vehicle comprises several adjacent storage modules, said vehicle can comprise, at least between two adjacent modules, at least one fire-resistant protection plate placed between said adjacent modules. Such a fireproof protection plate makes it possible to protect a storage module from a fire in the adjacent storage module and to delay as much as possible the spread of the fire from one module to another.

Advantageously, in the case where the vehicle comprises several adjacent storage modules, the vehicle according to the invention can comprise, at least between two adjacent modules, two fire-resistant protection plates placed between said adjacent modules, and placed at a distance from each other, in the direction of alignment of the modules.

In other words, two protection plates at a distance from each other can be placed between two adjacent modules, one on the side of one of the adjacent module and the other on the side of the other of the adjacent modules. Such a configuration makes it possible to better protect a storage module in the event of fire in an adjacent storage module.

Of course, when a storage module is placed between two storage modules, then one or two fire-resistant protection plate(s) can be placed between said module and each of said two modules.

The, or each, fire-resistant protection plate forms a plane perpendicular to the direction of alignment of the storage modules.

The, or each, fire-resistant protection plate can be fastened to the compartment in which the storage module is placed.

The, or each, fire-resistant protection plate can be made of sheet metal, for example of steel.

According to a non-limitative embodiment, at least one protective cover can be made of sheet metal.

Preferentially, at least one protective cover can be made of steel.

Such a protective cover is robust with respect to mechanical stresses.

Alternatively or in addition, at least one protective cover can be made of a non-combustible or non-flammable mineral matter.

Such a protective cover is lighter.

According to an embodiment, at least one protective cover can be fastened to an electrical energy storage module.

Alternatively or in addition, at least one protective cover can be fastened to a frame of said vehicle.

According to yet another alternative, the vehicle according to the invention can comprise, for at least one, in particular for each, storage module, a receptacle in the form of a tray, in which the storage module is placed, in particular individually.

In this case, at least one protective cover can be fastened to said receptacle.

Each receptacle can be made of sheet metal, and preferentially of steel.

The fastening of a cover can be carried out by standard fastening means, such as screws, bolts etc.

Advantageously, at least one protective cover can rotate, in particular about an axis parallel to the peripheral panel.

Such an architecture makes it possible to facilitate access to the storage module, for example with a view to maintenance, and makes it possible to avoid removing the cover entirely.

Advantageously, at least one protective cover can be equipped with at least on means of holding said protective cover in the open position, such as a cylinder, a spring, a stay etc.

According to an embodiment, at least one rechargeable electrical energy storage module can comprise one or more electrochemical batteries, in particular of the LMP® or Li-ion type.

Alternatively or in addition, at least one rechargeable electrical energy storage module can comprise one or more supercapacitor(s).

The vehicle according to the invention can be a bus, a coach or a tyred tram, in particular that is entirely electric.

In the present application, “tyred tram” denotes an electric public transport land vehicle mounted on wheels and which is recharged at each station, so that there is no need for heavy infrastructure of the rails or catenaries type on the road system. Such an electric vehicle is recharged at each station by means of charging elements of the station and a connector connecting said vehicle to said station.

According to an embodiment which is in no way limitative, the vehicle according to the invention can comprise:
four rechargeable electrical energy storage modules, called upper modules, positioned in the upper panel or roof of the vehicle and aligned in the longitudinal direction of the vehicle: each upper module can be equipped with an individual protective cover; and
four rechargeable electrical energy storage modules, called rear modules, positioned in the rear panel of the vehicle and aligned one above the other in a vertical direction: the rear modules are equipped with two vertical protective covers common to the four modules and positioned next to each other in a horizontal direction.

### DESCRIPTION OF THE FIGURES AND EMBODIMENTS

Other advantages and characteristics will become apparent on examination of the detailed description of an embodiment which is in no way limitative, and the attached drawings, in which:

FIG. 1 is a diagrammatic representation of a non-(imitative example of an electric vehicle according to the invention;

FIG. 2 is a partial diagrammatic representation of the upper panel of the vehicle in FIG. 1, in a top view;

FIG. 3 is a diagrammatic representation in an exploded view of a storage module of the vehicle in FIG. 1 and of its protective cover;

FIGS. 4a and 4b are very diagrammatic and very simplified representations of a storage module equipped with a protective cover, in a side view;

FIGS. 5 and 6 are partial diagrammatic representations, in cross section, of the rear portion of the vehicle in FIG. 1; and

FIG. 7 is a partial diagrammatic representation, in an isometric exploded view from above, of the rear portion of the vehicle in FIG. 1.

It is well understood that the embodiments that will be described below are in no way limitative. In particular, it is possible to imagine variants of the invention comprising only a selection of the characteristics described hereinafter, in isolation from the other characteristics described, if this selection of characteristics is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

In the figures, elements common to several figures retain the same reference.

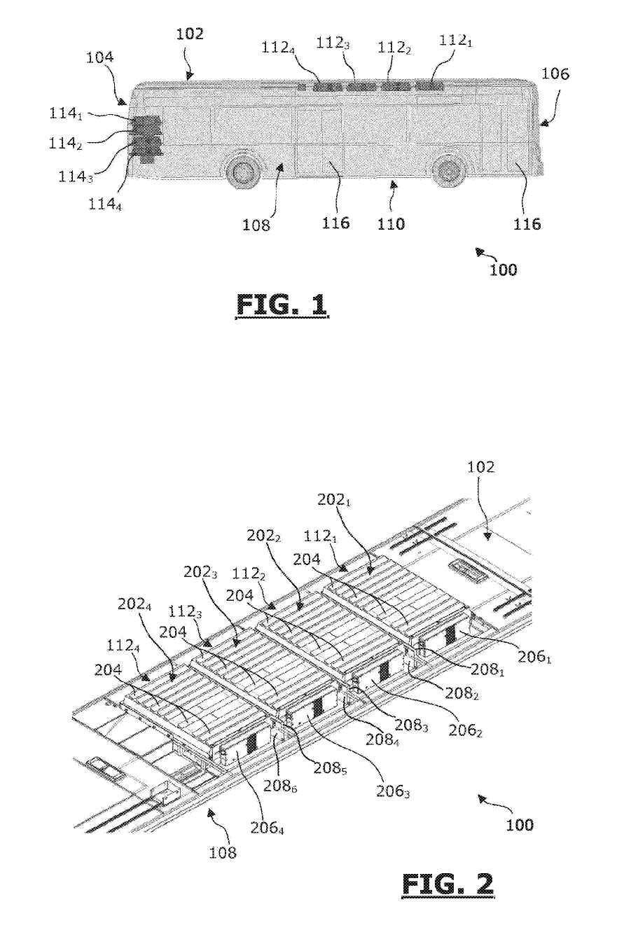

FIG. 1 is a diagrammatic representation, in a side view, of a non-limitative embodiment of a vehicle according to the invention.

The vehicle 100 shown in FIG. 1 is an electric bus.

The electric bus 100 contains an upper panel 102, a rear panel 104, a front panel 106, two side panels, of which only the side panel 108 is shown in FIG. 1, and a lower panel 110.

The electric bus 100 contains one or more electric motors (not shown) making it possible to set said bus in motion.

The bus 100 comprises four electrical energy storage modules 112₁-112₄, called upper modules, placed in a housing arranged in the upper panel 102 of the bus 100. In the example shown in FIG. 1, each upper storage module 112 is placed in the upper panel and substantially centred with respect to the side panels in the widthwise direction of the bus 100. The upper storage modules 112 are aligned behind one another in the longitudinal direction of the bus, at a distance from the front 106 and rear 104 panels, a little nearer to the front panel 106.

Each upper storage module 112 is fully incorporated in the thickness of the upper panel 102 so that none of the upper storage modules 112 projects from the upper panel 102, and more specifically from the upper face of the upper panel 102. The upper face of the upper panel 102 is thus smooth and has no element or shape that might create air resistance when the bus 100 is in motion.

The bus 100 also comprises four electrical energy storage modules 114₁-114₄, called rear modules, placed in a housing arranged in the rear panel 104 of the bus 100. In the example shown in FIG. 1, each rear storage module 114 is placed in the rear panel and substantially centred with respect to the side panels in the widthwise direction of the bus. The rear storage modules 114 are aligned above one another in the vertical direction.

Each storage module 112 and 114 can contain one or more batteries, one or more supercapacitor(s), etc., and more generally utilize any electrical energy storage technology, and preferentially LMP® batteries.

The bus 100 comprises doors 116, arranged in the side panel 108, and making it possible for passengers to get on and off the bus 100. The side panel 108 is that which is located on the pavement side.

Of course, the number of storage modules is not restricted to 8 and can be greater than or equal to 1. In particular, the number of storage modules corresponds to the maximum number of electrical energy storage modules which depends in particular on the weight of the vehicle and the operating range judged sufficient for the operation of the vehicle.

FIG. 2 is a partial diagrammatic representation, in a top view, of the upper panel of the vehicle in FIG. 1, without an outer trim element of said panel.

As shown in FIG. 2, each upper module 112₁-112₄ is placed in an individual housing, independent of the other modules 112₁-112₄.

Each module 112₁-112₄ is equipped with an individual protective cover, 202₁-202₄ respectively, placed above each module 112₁-112₄. Thus, each protective cover 202₁-202₄ of an upper storage module 112₁-112₄ can be removed individually from the other protective covers.

Each protective cover 202₁-202₄ contains openings for smoke and/or flames and/or gas to escape, each equipped with fixed louvres 204. Each louvre 204 of each cover 202 is orientated at an angle of 45° with respect to the general plane formed by the protective cover 202, or the general plane of the upper panel 102. In addition, each louvre 204 is orientated towards the side panel opposite to the side panel 108 which contains the doors 116 for getting on and off, so that the smoke and/or flames and/or gas are directed away from the panel 108. Thus, in the event of fire in one of the upper storage modules 112, passengers can get off the vehicle in less dangerous conditions, and will be less, if at all, exposed to the smoke/flames/gas when getting off the vehicle 100.

Each protective cover 202 can be made of sheet metal, preferably of steel, or of a fire-resistant mineral material.

In addition, in the example shown in FIG. 2, the protective cover 202 of an upper storage module 112 only covers the upper storage module 112 and leaves access to an electric/electronic management box of the associated storage module 112, 206₁-206₄ respectively, placed on the periphery of each module 112₁-112₄. In addition, the louvres 204 are directed in a direction away from the boxes 206, so that the latter are protected in the event of fire in one of the storage modules 112.

As shown in FIG. 2, fire-resistant protection plates 208₁-208₆ are placed between the storage modules 112₁-112₄.

In particular, two fire-resistant protection plates 208₁ and 208₂ are placed between the modules 112₁ and 112₂ at a distance from each other. The protection plate 208₁ is located on the side of the storage module 112₁ and is fastened to the compartment in which said module 112₁ is located and the protection plate 208₂ is located on the side of the storage module 112₂ and is fastened to the compartment in which said module 112₂ is located.

Two fire-resistant protection plates 208₃ and 208₄ are placed between the modules 112₂ and 112₃ at a distance from each other. The protection plate 208₃ is located on the side of the storage module 112₂ and is fastened to the compartment in which said module 112₂ is located and the protection plate 208₄ is located on the side of the storage module 112₃ and is fastened to the compartment in which said module 112₃ is located.

Two fire-resistant protective plate 208₅ and 208₆ are placed between the modules 112₃ and 112₄ at a distance from each other. The protection plate 208₅ is located on the side of the storage module 112₃ and is fastened to the compartment in which said module 112₃ is located and the protection plate 208₆ is located on the side of the storage module 112₄ and is fastened to the compartment in which said module 112₄ is located.

Each of the protection plates 208₁-208₆ forms a plane perpendicular to the longitudinal direction in which the modules 112₁-112₄ are aligned. Each protection plate 208₁-208₆ rises to the upper level of each storage module 112₁-112₄. Each protection plate 208₁-208₆ is preferably made of sheet metal.

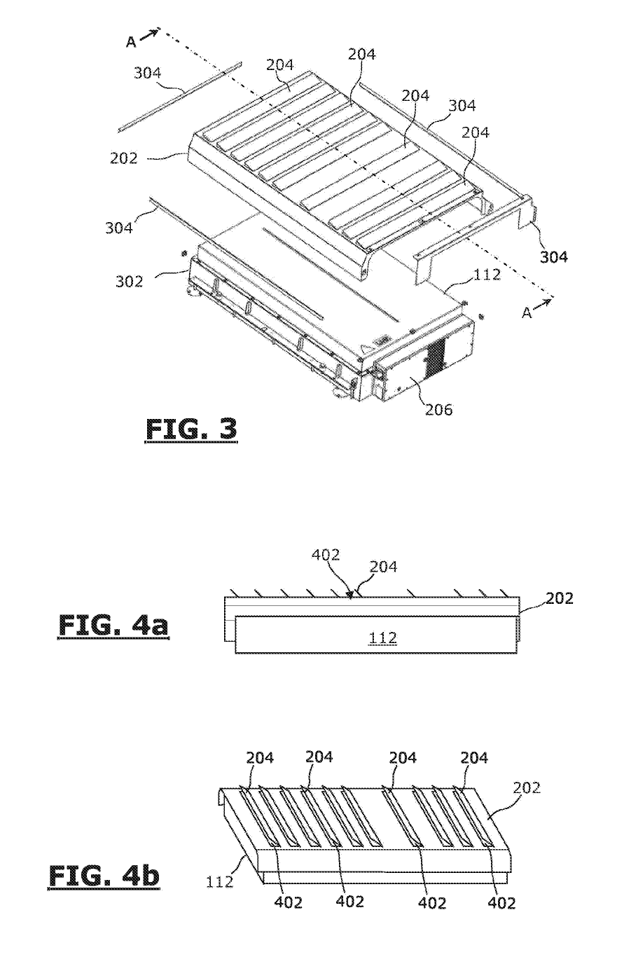

FIG. 3 is a diagrammatic representation in an exploded view of an upper storage module and of its protective cover.

The storage module 112 can be any one of the upper storage modules 112₁-112₄ shown in FIGS. 1 and 2. Similarly, the protective cover 202 can be any one of the protective covers 202₁-202₄ shown in FIGS. 1 and 2.

As shown in FIG. 3, the protective cover 202 of the upper module 112 has a cross-section in the shape of a “U”, so as to protect the upper face of the module 112, but also at least a portion of the two opposite side faces of the module 112.

The protective cover 202 is positioned in a transversal direction of the vehicle 100, so that each leg of the protective cover 202 in the shape of a “U”, i.e. each leg of the “U”, is substantially perpendicular to the longitudinal direction of the vehicle 100. As a result, each leg of the protective cover 202 protects a face of the upper module 112 in the transversal direction of the vehicle 100.

The protective cover 202 is fastened to a receptacle 302 in the form of a tray open at the top, and in which the storage module 112 is placed, by fastening rods 304.

FIGS. 4a and 4b are very diagrammatic and very simplified representations of an upper storage module 112 equipped with its protective cover 202, shown in FIG. 3.

FIG. 4a is a diagrammatic representation in cross-section along the line AA in FIG. 3, and FIG. 4b is a representation in an isometric view from the side.

The protective cover 202 has a general “U” shape, which covers the upper storage module 112 over its upper face and over a portion of its side faces. The protective cover 202 covers, at least in part, the side faces of the storage module 112 which, in use, are located on the side of the other adjacent storage modules, i.e. the side faces of the storage module 112 perpendicular to the direction in which the storage modules 112 are aligned.

Thus, the protective cover 202 makes it possible to channel smoke, flames and/or gas, and, more generally, the fire in the storage module 112, towards the evacuation openings 402 equipped with louvres 204.

The louvres 204 are directed at an angle, for example of 45°, and make it possible for the smoke/flames/gas due to a fire to escape in a direction posing the least danger for pedestrians and people getting off the vehicle, or more generally near to the vehicle.

The protective cover 202 contains, for example, ten louvres 204 directed, for example, at an angle of 45°, and which make it possible for the smoke/flames/gas caused by a fire to escape in a direction posing the least danger for pedestrians and people getting off the vehicle, or more generally near to the vehicle.

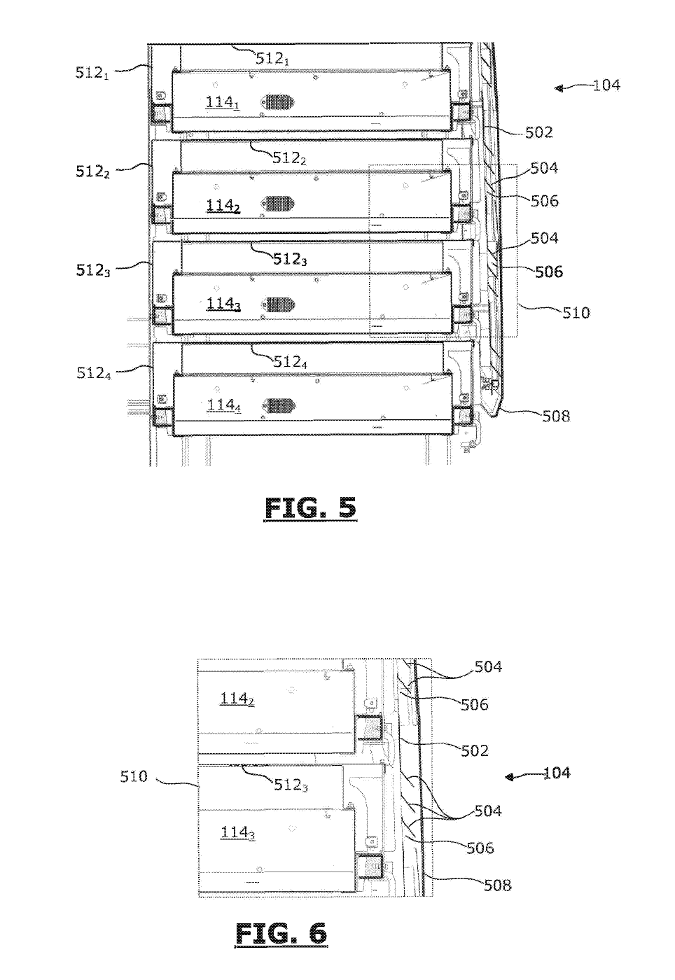

FIG. 5 is a partial diagrammatic representation, in cross-section, of the rear panel of the vehicle in FIG. 1.

As shown in FIG. 5, each rear module 114₁-114₄ is placed in an individual housing, independent of the other modules 114₁-114₄. Each individual housing is in the form of a rack.

In the example shown in FIG. 5, the storage modules 114₁-114₄ are aligned in a vertical direction.

The rear panel 104 contains one or more protective covers 502. Each protective cover 502 is placed vertically in front of the rear storage modules 114₁-114₄, substantially over the full height of the four rear storage modules 114₁-114₄.

The, or each, protective cover 502 contains louvres 504. Each louvre 504 is positioned on the periphery of an opening allowing the smoke/flames/gas to escape and is directed downwards at an angle of 45° with respect to the general plane formed by the protective cover 502 or the rear panel 104. Thus, in the event of fire, the smoke/flames/gas are directed downwards, i.e. towards the ground, which makes it possible to better protect the people/objects located around the vehicle 100.

Each protective cover 502 can be made of sheet metal or of a fire-resistant mineral material.

Each protective cover 502 is fastened to the frame of the vehicle, and in particular to the housings in which the rear modules 114 are positioned, for example by screws or bolts.

A trim element 508 of the rear face of the vehicle 100 is placed in front of the, or of each, protective cover 502.

FIG. 6 is a detailed diagrammatic representation of the area referenced 510 in FIG. 5.

In addition, the vehicle comprises, between each adjacent storage module 114₁-114₂ a plate 512 for protecting against fire in order to avoid the spread of a fire from a storage module to the adjacent storage module or towards the passenger compartment. Thus, a protection plate 512₁ is placed above the storage module 114₁, a protection plate 512₂ is placed between the storage modules 114₁ and 114₂, a protection plate 512₃ is placed between the storage modules 114₂ and 114₃ and a protection plate 512₄ is placed between the storage modules 114₃ and 114₄.

Each of the protection plates 512 forms a plane perpendicular to the vertical direction in which the modules 114₁-114₄ are aligned. Each protection plate 512₁-512₄ is made of sheet metal.

Furthermore, each protection plate 512 covers, at least in part, the side face of a storage module 114 located on the side of the passenger compartment. Thus, the protection plate 512₁ covers at least in part the side face of the storage module 114₁ located on the side of the passenger compartment, the protection plate 512₂ covers at least in part the lateral face of the storage module 114₂ located on the side of the passenger compartment, and so on.

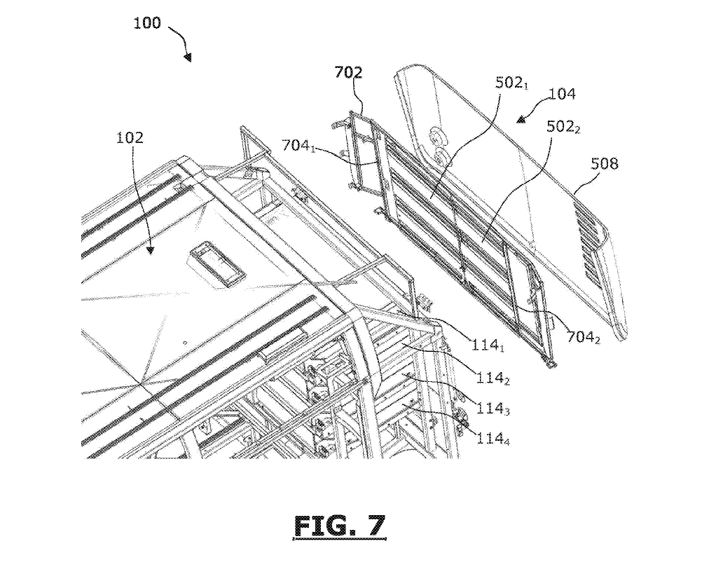

FIG. 7 is a partial diagrammatic representation, in an isometric exploded view from above, of the rear portion of the vehicle 100 in FIG. 1.

As shown in FIG. 7, the vehicle 100 comprises two protective covers 502₁ and 502₂ for the rear modules 114₁-114₄. Each protective cover 502₁ and 502₂ is common to the four rear modules 114₁-114₄. Each protective cover 502₁ and 502₂ extends substantially over:
the full height of the modules 114₁-114₄, in the heightwise direction of the vehicle 100; and
a portion of the width of the modules 114₁-114₄, in the widthwise direction of the vehicle 100.

Each protective cover 502 contains four series of evacuation openings 506 (FIG. 5). Each series of evacuation openings is placed facing a rear storage module 114. Each evacuation opening 506 of each series is equipped with a louvre 504 inclined downwards at an angle of 45°.

The protective covers 502₁ and 502₂ are fastened to the frame of the vehicle 100 by a framework 702.

Each protective cover 502₁-502₂ is arranged on the framework 702 rotatively about a vertical shaft, 704₁ and 704₂ respectively, so that each cover 502₁-502₂ can be opened in order to access the rear storage modules 114.

Of course, the invention is not limited to the examples detailed above. For example, the invention is not limited to buses and can for example be applied to tyred trams, to coaches and to other public transport vehicles.

In addition, the vehicle according to the invention can comprise at least one means of holding at least one cover in the open position.

Moreover, the number and the position of the storage modules is not limitative. In particular, the number of storage modules corresponds to the maximum number of electrical energy storage modules which depends in particular on the weight of the vehicle and the operating range judged sufficient for the operation of the vehicle.

1. An electric public transport land vehicle, in particular of the bus or coach or tyred tram type, comprising: at least one rechargeable electrical energy storage module arranged in a peripheral panel of said vehicle; for at least one electrical energy storage module, a protective cover equipped with at least one evacuation opening for allowing smoke and/or flame and/or gas to escape, in a direction away from the vehicle, in the event of fire in said module.

2. The vehicle according to claim 1, characterized in that at least one said protective cover of a module has a shape folded on at least two of its sides, in particular a “U” shape, so as to cover a first face of said module, turned towards the outside of said vehicle, and at least a portion of two faces of said module adjacent to said first face.

3. The vehicle according to claim 1, characterized in that for at least one said protective cover, at least one evacuation opening is equipped with a fixed louvre.

4. The vehicle according to claim 1, characterized in that for at least one said protective cover, at least one evacuation opening is equipped with a louvre that is mobile in rotation.

5. The vehicle according to claim 1, characterized in that at least one opening of the protective cover is directed in a direction forming an angle greater than or equal to 30° with respect to the peripheral panel, and in particular an angle comprised between 30° and 60°, and even more particularly an angle equal to 45°.

6. The vehicle according to claim 1, characterized in that at least one module is placed in the upper panel of said vehicle, the protective cover being placed above said module.

7. The vehicle according to claim 1, characterized in that at least one evacuation opening of at least one said protective cover is directed in a direction away from a panel of the vehicle comprising the doors for passengers to board and get off a passenger compartment of said vehicle.

8. The vehicle according to claim 1, characterized in that it comprises at least one electric/electronic management box for at least one storage module, positioned on the periphery of said at least one storage module, at least one evacuation opening of the protective cover being directed in a direction away from said at least one electric/electronic management box.

9. The vehicle according to claim 1, characterized in that it comprises at least one electric/electronic management box for at least one storage module, positioned on the periphery of said at least one storage module, at least one said protective cover extending between said at least one management box and at least one storage module.

10. The vehicle according to claim 1, characterized in that at least one module is placed in a rear panel of said vehicle, the protective cover being placed in front of said module, viewed from the rear panel.

11. The vehicle according to the claim 10, characterized in that at least one evacuation opening of one said protective cover is directed downwards.

12. The vehicle according to claim 1, characterized in that it comprises several adjacent storage modules aligned in a given direction.

13. The vehicle according to the claim 12, characterized in that it comprises, at least between two adjacent modules, at least one fire-resistant protection plate placed between said adjacent modules.

14. The vehicle according to the claim 13, characterized in that it comprises, at least between two adjacent modules, two fire-resistant protection plates placed between said adjacent modules, and placed at a distance from each other, in the given direction.

15. The vehicle according to claim 12, characterized in that it comprises an individual said protective cover for at least one, in particular each, adjacent module.

16. The vehicle according to claim 12, characterized in that it comprises none said protective cover common to at least two, in particular to all, of said adjacent modules.

17. The vehicle according to claim 1, characterized in that at least one said protective cover is made of sheet metal, in particular of steel.

18. The vehicle according to claim 1, characterized in that it comprises, for at least one storage module, a receptacle, in the form of a tray, in which said storage module is placed, at least one said protective cover being fastened to said receptacle.

19. The vehicle according to claim 1, characterized in that at least one said protective cover is rotary.

20. The vehicle according to claim 1, characterized in that at least one rechargeable electrical energy storage module comprises one or more supercapacitor(s).
